(19) United States
(12) Patent Application Publication
(10) Pub. No.: US 2011/0131127 A1
(43) Pub. Date: Jun. 2, 2011

(54) Distribution Of Financial Instruments Among Counterparties

(75) Inventors: Vinayek K. Singh, Litchfield, CT (US); Ashok H. Mittal, Tinton Falls, NJ (US); Malcom P. Walley, Guilford, CT (US); Stephen Richard Gould, Merrick, NY (US)

(73) Assignee: Vyapar Capital Market Partners LLC

(21) Appl. No.: 12/626,763

(22) Filed: Nov. 27, 2009

(51) Int. Cl. G06Q 40/00; G06Q 10/00

(52) U.S. Cl. 705/37; 705/35

(57) ABSTRACT

A computer implemented method and system is provided for distributing aggregated financial instruments among counterparties. The counterparties' financial instrument positions are acquired along with risk measures. The financial instrument positions are weighted using the risk measures to obtain risk weighted positions. An aggregate risk is computed by aggregating the risk weighted positions of the financial instruments. A position risk is computed by aggregating the risk weighted positions of the counterparties. A financial instrument with highest aggregate risk is allocated to a counterparty with highest position risk based on predefined rules. The position risks are recomputed by aggregating the risk weighted positions modified due to the allocation. An unallocated financial instrument with highest aggregate risk is allocated to a counterparty with highest change in position risk after the recomputation. Recomputation of the position risk and allocation of the unallocated financial instruments are performed until the financial instruments are completely allocated.

### BACKGROUND

The computer implemented method and system disclosed herein, in general, relates to trade management. More particularly, the computer implemented method and system disclosed herein relates to distributing aggregated financial positions among multiple counterparties.

Firms trading in financial instruments such as securities or derivatives typically acquire a large number of positions in different financial instruments. The financial instrument positions may be individually small and cumbersome to manage. A large number of small financial instrument positions are also difficult to trade and may fetch lower prices than large financial instrument positions. The financial positions that are difficult to trade have an adverse effect on the liquidity of the firms.

Multiple firms holding small positions of similar financial instruments may come together as counterparties to trade in small financial instrument positions with each other to consolidate the financial instrument positions. However, regulation of the trading is difficult in the absence of a central mediator dealing with the counterparties and aggregating each of the financial instruments and distributing the aggregated financial instruments among the counterparties. Additionally, unarbitrated trade may result in drastic changes in the counterparties' total position risk, wherein a counterparty with a high initial risk position acquires a very low final risk position after the trade, and a counterparty with a low initial risk position acquires a very high final risk position.

Furthermore, sorting algorithms for allocating and distributing the financial instruments may have some mathematical similarities with a class of problems known as “NP-complete” where a best or most efficient solution is sought. Hence, a perfectly efficient algorithm for the allocation and distribution is very complicated and lengthy to implement.

Hence, there is an unmet need for distributing aggregated financial positions among multiple counterparties such that the total risk position of each of the counterparties is not changed significantly, using an efficient set of rules.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for distributing aggregated financial positions among multiple counterparties such that the total risk position of each of the counterparties is not changed significantly, using an efficient set of rules. The counterparties are buyers and sellers of the same or similar financial instruments. Financial instrument positions associated with financial instruments held by the counterparties are acquired, along with one or more risk measures for each of the financial instruments. The financial instruments are, for example, securities, derivatives, or a combination thereof. The financial instrument position of a financial instrument represents the amount of the financial instruments held by a counterparty. Each of the held financial instrument positions is weighted using the acquired risk measures to obtain risk weighted positions. An aggregate risk is computed for each of the financial instruments by aggregating the risk weighted positions of each of the financial instruments. In an embodiment, the financial instruments are ranked in descending order of aggregate risk.

A position risk is computed for each of the counterparties by aggregating the risk weighted positions of each of the counterparties. In an embodiment, the counterparties are ranked in descending order of position risk. A financial instrument with the highest aggregate risk is allocated to a first counterparty with the highest position risk based on predefined rules. The predefined rules allocate the financial instrument with the highest aggregate risk to the counterparty with the highest position risk only if the counterparty holds a financial instrument position similar to and of same sign as the financial instrument of at least a predefined value. The sign denotes mode of trade of the financial instrument. A plus sign denotes a purchase or a “long position”, while a minus sign denotes a sale or a “short position”.

A position risk for each of the counterparties is recomputed by aggregating the risk weighted positions modified due to the allocation. In an embodiment, the counterparties are re-ranked in descending order of change in position risk after each allocation. An unallocated financial instrument with the highest aggregate risk is allocated to a second counterparty with the highest change in position risk after the recomputation. The recomputation of the position risk and the allocation of unallocated financial instruments are performed until the allocation of the financial instruments is complete. The aggregated financial instruments are thereby distributed among the counterparties.

Final position risks of the counterparties are computed after the allocation of the financial instruments. Difference between the position risks of the counterparties computed before the allocation and the position risks of the counterparties computed after the allocation, is computed. The computed difference furnishes information on the change in position risk of each of the counterparties. The position risks of the counterparties are not significantly changed after the allocation and distribution.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of distributing aggregated financial instruments among multiple counterparties.

FIG. 2 exemplarily illustrates a computer implemented system for distributing aggregated financial instruments among multiple counterparties.

FIG. 3 exemplarily illustrates the architecture of a computer system employed in a financial instrument distribution server and the computing devices used by the counterparties.

FIGS. 4A-4P exemplarily illustrate distribution of financial instruments among counterparties.

### DETAILED DESCRIPTION OF THE INVENTION

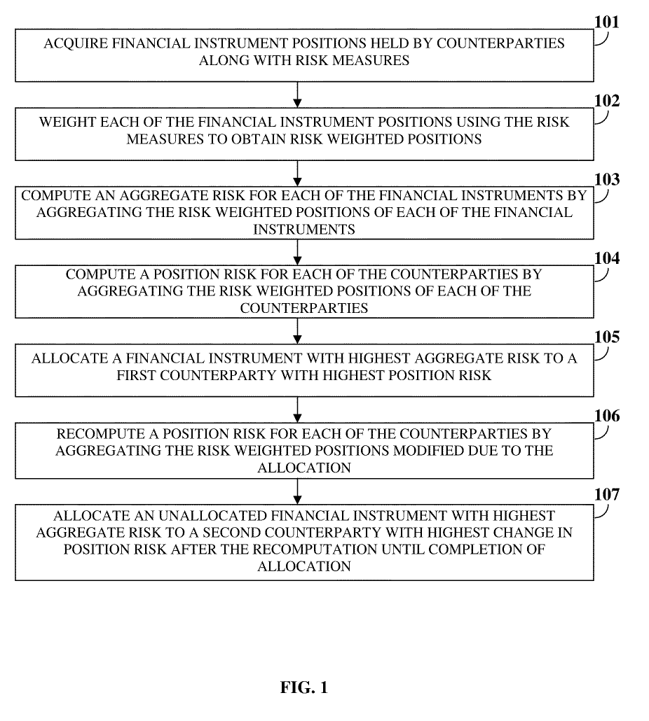

FIG. 1 illustrates a computer implemented method of distributing aggregated financial instruments among multiple counterparties. As used herein, the counterparties are buyers and sellers of the same or similar financial instruments. Financial instrument positions associated with financial instruments held by the counterparties are acquired 101, along with one or more risk measures for each of the financial instruments. As used herein, “financial instruments” refers to evidence of an ownership interest in an entity, for example, bonds and securities. “Financial instrument positions” refers to ownership of or exposure to a financial instrument. The financial instruments are securities, derivatives, or a combination thereof. Each of the counterparties provides a total risk measure for the financial instruments. The total risk measure is, for example, in the form of dollar value (DV01), dollar duration, market beta, portfolio delta, etc., following market conventions for the financial instruments and the risk measures. As used herein, “risk measures” refer to predictors of investment risk and volatility of the financial instruments. One of the risk measures is, for example, the duration of the financial instruments.

Each of the held financial instrument positions is weighted 102 using the acquired risk measures to obtain risk weighted positions. An aggregate risk is computed 103 for each of the financial instruments by aggregating the risk weighted positions of each of the financial instruments. As used herein, the term “aggregate risk” of a financial instrument refers to a summation of the risk weighted positions of the financial instruments across the counterparties. The aggregate risk is computed by multiplying market value of each of the financial instrument positions with the risk measure and summing the results. Hence, each financial instrument obtains a single consolidated value of aggregate risk. In an embodiment, the financial instruments are ranked in descending order of aggregate risk.

A position risk is computed 104 for each of the counterparties by aggregating the risk weighted positions of each of the counterparties. As used herein, the term “position risk” of a counterparty refers to an indication of the total risk of the counterparty due to the financial instrument positions held by the counterparty. In an embodiment, the counterparties are ranked in descending order of the position risk. A financial instrument with the highest aggregate risk from the financial instruments is allocated 105 to a first counterparty with highest position risk from the counterparties based on predefined rules. The predefined rules allocate the financial instrument with the highest aggregate risk to the counterparty with the highest change in position risk only if the counterparty holds a financial instrument position similar to and of same sign as the financial instrument of at least a predefined value. The sign denotes mode of trade of the financial instrument. For example, a plus sign denotes a purchase or a “long position”, while a minus sign denotes a sale or a “short position”.

In one embodiment for example, four predefined rules are used. The first predefined rule is, for example, the “size rule”. According to the size rule, a financial instrument can be allocated to a counterparty only if the counterparty holds a position of at least a predefined value in the financial instrument. The predefined value may be modified as per requirements of individual cases. For example, a counterparty with a position of 20% or less of the aggregated value of a particular financial instrument is not allocated that financial instrument.

The second predefined rule is, for example, the “sign rule”. According to the sign rule, a financial instrument can be allocated to a counterparty only if the counterparty holds a position in the financial instrument of the same sign as the aggregated financial instrument. The sign denotes mode of trade of the financial instrument by the counterparties. A plus sign denotes a purchase or a “long position”, while a minus sign denotes a sale or a “short position”. In an example, a financial instrument with a plus sign is not allocated to a counterparty holding a position with a minus sign in the financial instrument.

The third predefined rule is, for example, the “single counterparty rule”. According to the single counterparty rule, if only one counterparty can be allocated a particular financial instrument because of the size rule and the sign rule, then the allocation takes place before the fourth rule is applied. The fourth predefined rule is, for example, the “sorting rule”. The sorting rule is described in detail in the following paragraph. An embodiment using four predefined rules is described herein for purposes of illustration. However, in actual implementation, any number of predefined rules may be used to allocate the financial instruments to the counterparties.

Due the allocation of the financial instrument to the first counterparty, the financial instrument positions of the counterparties get modified. The modified financial instrument positions cause the risk weighted positions to change. Position risk for each of the counterparties is then recomputed 106 by aggregating the risk weighted positions thus changed due to the allocation. In an embodiment, the counterparties are re-ranked in descending order of change in position risk after each allocation. An unallocated financial instrument with the highest aggregate risk from the financial instruments is allocated 107 to a second counterparty with the highest change in position risk after the recomputation. The recomputation of the position risk and the allocation of the unallocated financial instruments are performed until the allocation of the financial instruments is complete. After each allocation, the risk weighted positions change, hence the position risk for each of the counterparties is recomputed after every allocation. The recomputation and allocation continues till all the financial instruments are allocated to the counterparties. The aggregated financial instruments are thereby distributed among the counterparties.

Final position risks of the counterparties are computed after the allocation of the financial instruments. Difference between the position risks of the counterparties computed before the allocation and the position risks of the counterparties computed after the allocation is computed. The computed difference furnishes information on the change in position risk of each of the counterparties. The computed difference is displayed to the counterparties. The position risks of the counterparties are typically not significantly changed after the allocation and distribution.

FIG. 2 exemplarily illustrates a computer implemented system 200 for distributing aggregated financial instruments among multiple counterparties 202. The computer implemented system 200 comprises a financial instrument distribution server 201. The financial instrument distribution server 201 comprises a position acquisition module 201a, a weighting engine 201b, an aggregate risk computation module 201c, an allocation engine 201d, a position risk computation module 201f, a ranking module 201e, and a difference computation module 201g. Each of the counterparties 202 accesses the financial instrument distribution server 201 via a network 204, using a computing device 203. The network 204 is, for example, the internet. For purposes of illustration, three counterparties 202, namely, a first counterparty 202a, a second counterparty 202b, and a third counterparty 202c are exemplarily illustrated in FIG. 2. However, any number of counterparties 202 may access the financial instrument distribution server 201 and participate in aggregation and distribution of the financial instruments.

The position acquisition module 201a acquires financial instrument positions associated with financial instruments held by the counterparties 202 along with one or more risk measures for each of the financial instruments. The financial instruments are, for example, securities, derivatives, or a combination thereof. The weighting engine 201b weights each of the held financial instrument positions using the acquired risk measures to obtain risk weighted positions. The aggregate risk computation module 201c computes an aggregate risk for each of the financial instruments by aggregating the risk weighted positions of each of the financial instruments. The ranking module 201e ranks the financial instruments in descending order of aggregate risk.

The position risk computation module 201f computes a position risk for each of the counterparties 202 by aggregating the risk weighted positions of each of the counterparties 202. The ranking module 201e ranks the counterparties 202 in descending order of position risk. The allocation engine 201d allocates a financial instrument with the highest aggregate risk from the financial instruments to a first counterparty 202a with the highest position risk from the counterparties 202 based on predefined rules as disclosed in the detailed description of FIG. 1. The allocation engine 201d utilizes the predefined rules to allocate the financial instrument with the highest aggregate risk to the counterparty 202a, 202b, or 202c with the highest change in position risk if the counterparty 202a, 202b, or 202c holds a financial instrument position similar to and of same sign as the financial instrument of at least a predefined value.

The position risk computation module 201f recomputes a position risk for each of the counterparties 202 by aggregating the risk weighted positions modified due to the allocation. The ranking module 201e re-ranks the counterparties 202 in descending order of the change in position risk after each allocation. The allocation engine 201d allocates an unallocated financial instrument with the highest aggregate risk from the financial instruments to a second counterparty 202b with the highest change in position risk after the recomputation. The recomputation of the position risk and the allocation of the unallocated financial instruments are performed until the allocation of the financial instruments is complete.

The position risk computation module 201f computes position risks of the counterparties 202 after the allocation of the financial instruments. The difference computation module 201g computes difference between the position risks of the counterparties 202 computed before the allocation and the position risks of the counterparties 202 computed after the allocation. The computed difference furnishes information on the change in position risk of each of the counterparties 202.

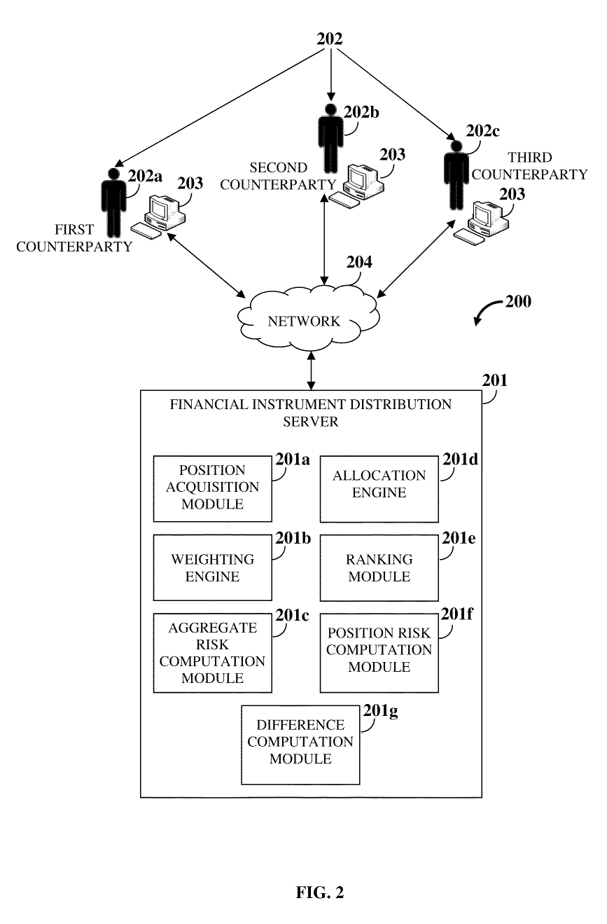

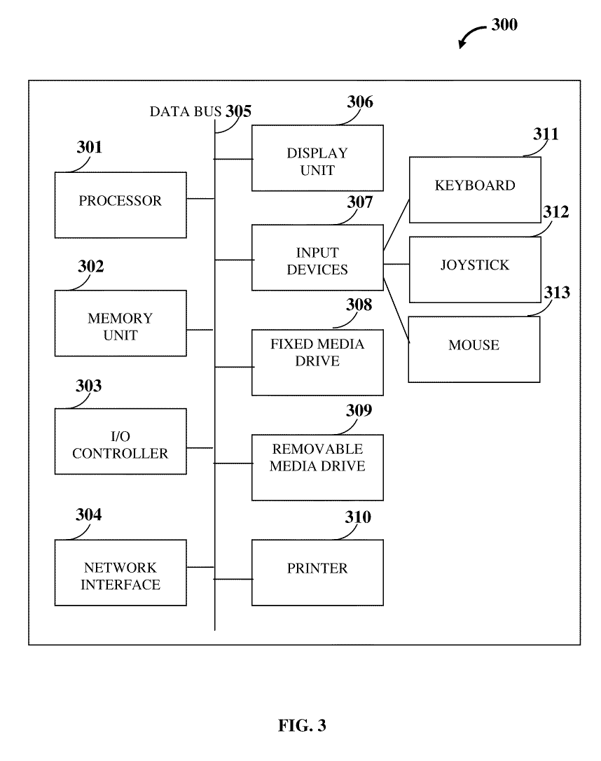

FIG. 3 exemplarily illustrates the architecture of a computer system 300 employed in the financial instrument distribution server 201 and the computing device 203 used by each of the counterparties 202 to access the financial instrument distribution server 201 via the network 204. The computing device 203 is, for example, a desktop computer, a laptop computer, a handheld computer, a personal digital assistant (PDA), a mobile computing device, etc. The network 204 is, for example, the internet or an intranet.

The computer system 300 comprises a processor 301, a memory unit 302, an input output (I/O) controller 303, a network interface 304, a display unit 306, input devices 307, a fixed media drive 308, a removable media drive 309, and output devices, for example, a printer 310, communicating via a data bus 305. The output devices receive and read digital data on, for example, a compact disk, a digital video disk or other medium.

The processor 301 is an electronic circuit that executes computer programs. The memory unit 302 is used for storing programs and applications. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301. The network interface 304 enables connection of the computer system 300 to the network 204. The I/O controller 303 controls the input and output actions performed by the counterparties 202. The data bus 305 permits communication between the modules, for example, 201a, 201b, 201c, 201d, 201e, 201f, and 201g of the financial instrument distribution server 201.

The display unit 306 displays computed results to the counterparties 202. The input devices 307 are used for inputting data into the computer system 300. The input devices 307 are, for example, a keyboard 311 such as an alphanumeric keyboard, a joystick 312, a mouse 313, etc. The computer system 300 further comprises a fixed media drive 308 and a removable media drive 309 for receiving removable media. The computer system 300 on the computing device 203 communicates with the computer system 300 of the financial instrument distribution server 201 and other computer systems through the network interface 304.

Computer applications and programs are used for operating the computer system 300. The programs are loaded onto the fixed media drive 308 and into the memory unit 302 of the computer system 300 via the removable media drive 309. In an embodiment, the computer applications and programs may be loaded directly through the network 204. Computer applications and programs are executed by double clicking a related icon displayed on the display unit 306 using one of the input devices 307. The counterparties 202 interact with the financial instrument distribution server 201 using a graphical user interface (GUI) of the display unit 306.

The computer system 300 of the financial instrument distribution server 201 employs an operating system for performing multiple tasks. The operating system is responsible for the management and coordination of activities and the sharing of the resources of the computer system 300. The operating system further manages security of the computer system 300, peripheral devices connected to the computer system 300, and network connections. The operating system employed on the computer system 300 recognizes, for example, inputs provided by the counterparties 202 using one of the input devices 307, and manages the output display, files and directories stored locally on the fixed media drive 308, etc. The operating system on the computer system 300 executes different programs initiated by the counterparties 202 using the processor 301.

Data entered by the counterparties 202 on the computing device 203 is processed and transferred to the financial instrument distribution server 201 by the operating system with the help of the processor 301, for example, a central processing unit (CPU). The operating system monitors the use of the processor 301. The operating system schedules the work performed by the processor 301 in the form of a process or a thread. The processes and threads are signals sent by the operating system to the processor 301 for processing information, for example, information on financial instrument positions, risk measures, etc. The financial instrument distribution server 201 communicates with the counterparties 202 via a network 204, for example, a local area network (LAN), a wide area network (WAN), a Wi-Fi network, etc. Instructions for executing the functions performed by the financial instrument distribution server 201 are retrieved by the processor 301 from the program memory in the form of signals. The location of the instructions in the program memory is determined by a program counter (PC). The program counter stores a number that identifies the current position in the program.

The instructions fetched by the processor 301 from the program memory after being processed are decoded. After processing and decoding, the processor 301 executes the instructions. For example, the position acquisition module 201a defines the instructions for acquiring financial instrument positions associated with financial instruments held by the counterparties 202 along with one or more risk measures for each of the financial instruments. The weighting engine 201b defines the instructions for weighting each of the held financial instrument positions using the acquired risk measures to obtain risk weighted positions. The aggregate risk computation module 201c defines the instructions for computing an aggregate risk for each of the financial instruments. The position risk computation module 201f defines the instructions for computing a position risk for each of the counterparties 202. The allocation engine 201d defines the instructions for allocating a financial instrument with the highest aggregate risk to a first counterparty 202a with the highest position risk based on predefined rules. The difference computation module 201g defines the instructions for computing difference between the position risks of the counterparties 202 computed before the allocation and the position risks of the counterparties 202 computed after the allocation.

The processor 301 retrieves the instructions defined by the position acquisition module 201a, the weighting engine 201b, the aggregate risk computation module 201c, the position risk computation module 201f, the allocation engine 201d, the difference computation module 201g, etc. and executes the instructions. Output of the processor 301 comprising results of the computations and the allocation are displayed on the display unit 306 of the computer system 300 of the counterparties 202. The counterparties 202 interact with the computer system 300 using a graphical user interface (GUI) of the display unit 306.

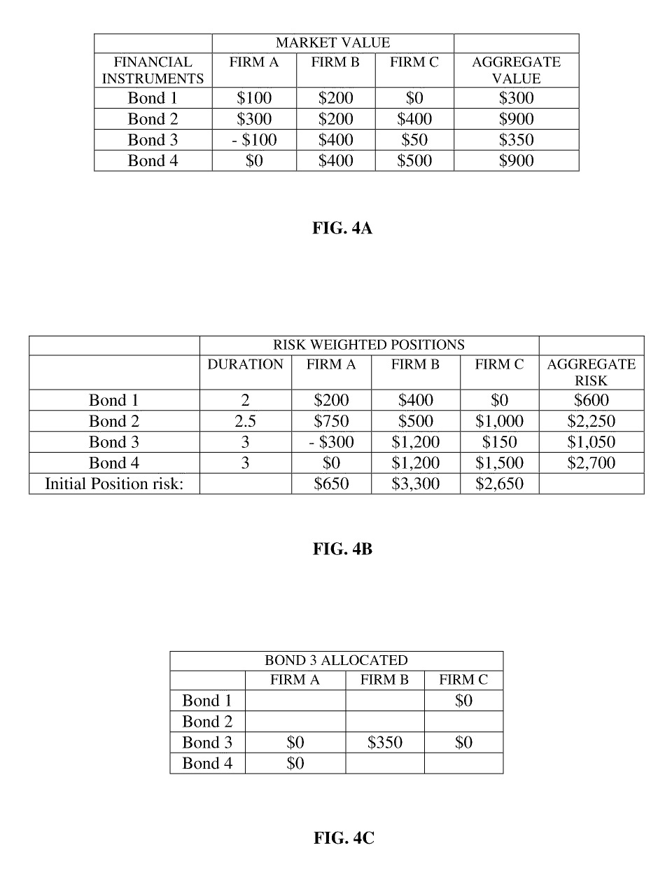

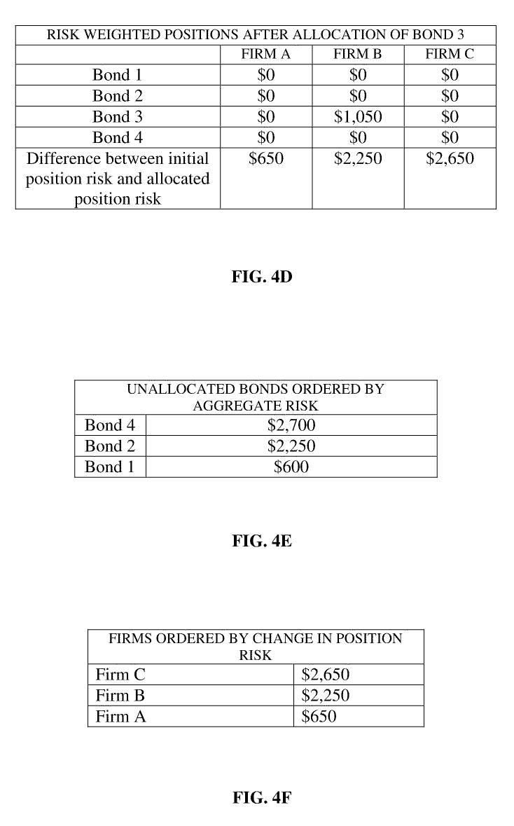

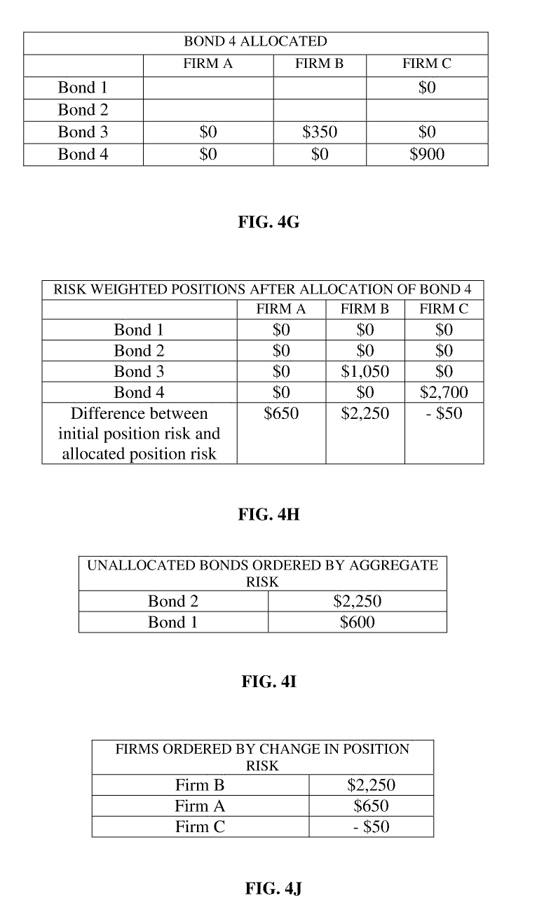

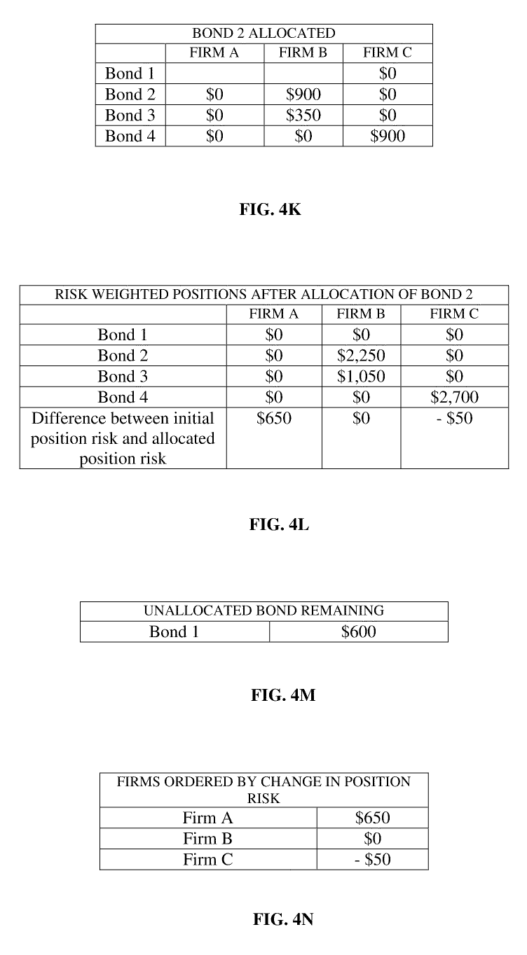

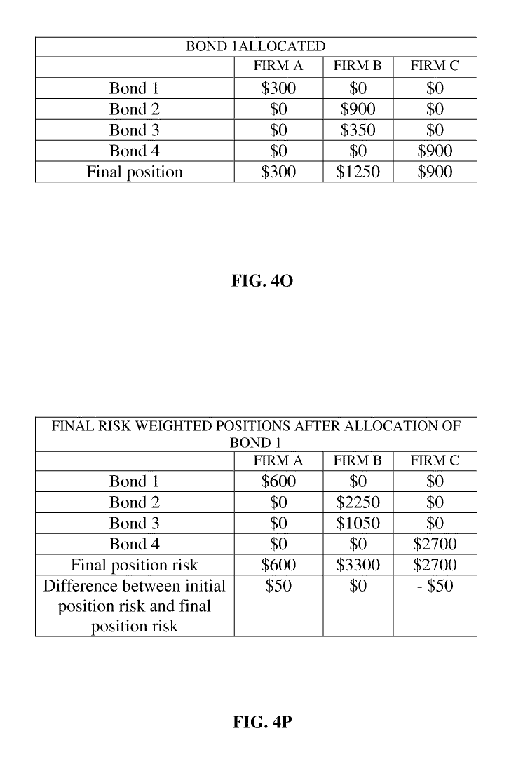

FIGS. 4A-4P exemplarily illustrate distribution of financial instruments among counterparties 202. For purposes of illustration, the example considered herein describes distribution of four financial instruments bond 1, bond 2, bond 3, and bond 4 among three counterparties 202, namely, Firm A, Firm B, and Firm C.

FIG. 4A illustrates initial positions associated with the financial instruments held by the counterparties 202. The financial instrument positions are based on market values of the financial instruments. Firm A holds $100 of bond 1, $300 of bond 2, −$100 of bond 3, and $0 of bond 4. The minus sign for bond 3 denotes a selling position or a “short” position. Firm B holds $200 of bond 1, $200 of bond 2, $400 of bond 3, and $400 of bond 4. Firm C holds $0 of bond 1, $400 of bond 2, $50 of bond 3, and $500 of bond 4. The aggregate market value of bond 1 across the counterparties 202 is $300, that of bond 2 is $900, that of bond 3 is $350, and that of bond 4 is $900.

The risk measure considered in this example is duration of the financial instruments. To obtain the risk weighted financial instrument positions, the initial financial instrument positions are multiplied by the duration. The risk weighted positions of each of the counterparties 202 for each of the financial instruments is illustrated in FIG. 4B. The risk weighted positions across the counterparties 202 are aggregated for each of the financial instruments to obtain aggregate risk for each of the financial instruments. As illustrated in FIG. 4B, the aggregate risk for bond 1 is $600, for bond 2 is $2,250, for bond 3 is $1,050, and for bond 4 is $2,700. Next, the risk weighted positions across the financial instruments are aggregated for each of the counterparties 202 to obtain position risk for each of the counterparties 202. As illustrated in FIG. 4B, the position risk of Firm A is $650, of Firm B is $3,300, and of Firm C is $2,650.

Applying the first predefined rule, namely, the “size rule”, and considering the predefined value to be 20% of the aggregate value of the financial instrument, Firm C is disqualified from being allocated either bond 1 or bond 3, since Firm C holds positions of less than 20% in both bond 1 and bond 3. Similarly, bond 4 cannot be allocated to Firm A because of the size rule.

Now applying the “sign rule”, bond 3 cannot be allocated to Firm A, since Firm A holds a short position (minus sign) in bond 3, and the aggregate value of bond has a plus sign. By the “single counterparty rule”, since Firm B is the only counterparty eligible to be allocated bond 3, bond 3 is allocated to Firm B before the fourth rule, the “sorting rule”, is applied.

By allocating bond 3 to Firm B, the positions held and the risk weighted positions of the counterparties 202 in bond 3 are modified. The modified positions after the allocation of bond 3 to Firm B are exemplarily illustrated in FIG. 4C. Firm B now holds a position of $350 in bond 3, while Firm A and Firm C both hold $0. The modified risk weighted positions after the allocation of bond 3 to Firm B is exemplarily illustrated in FIG. 4D. Firm B now holds a risk weighted position of $1050 in bond 3, while Firm A and Firm C both hold $0. Difference between initial position risk and position risk after the allocation is computed for the counterparties 202.

The “sorting rule” is now applied. The unallocated financial instruments bond 1, bond 2, and bond 4 are ranked in descending order of aggregate risk, as exemplarily illustrated in FIG. 4E. The counterparties 202 are re-ranked in descending order of the computed difference between initial position risk and position risk, as exemplarily illustrated in FIG. 4F. The financial instrument with the highest aggregate risk, bond 4, is allocated to the counterparty with the highest change in position risk, Firm C. Firm C now holds a $900 position in bond 4, while Firm A and Firm B both hold $0, as exemplarily illustrated in FIG. 4G. Risk weighted positions of the counterparties 202 after the allocation of bond 4 is exemplarily illustrated in FIG. 4H. As illustrated in FIG. 4H, the difference between initial position risk and the position risk after the allocation of bond 4 is $650 for Firm A, $2,250 for Firm B, and −$50 for Firm C.

The unallocated bonds, bond 1 and bond 2, are now ranked in descending order of aggregate risk, as exemplarily illustrated in FIG. 4I. The counterparties 202 are re-ranked in descending order of change in position risk, as exemplarily illustrated in FIG. 4J. The unallocated financial instrument with the highest aggregate risk, bond 2, is allocated to the counterparty with the highest change in position risk, Firm B. As exemplarily illustrated in FIG. 4K, Firm B now holds $900 in bond 2, while Firm A and Firm C hold $0. Risk weighted positions of the counterparties 202 after the allocation of bond 2 to Firm B is exemplarily illustrated in FIG. 4L. As illustrated in FIG. 4L, the difference between initial position risk and the position risk after the allocation of bond 2 is $650 for Firm A, $0 for Firm B, and −$50 for Firm C.

Only one unallocated bond, bond 1, now remains, as illustrated in FIG. 4M. The counterparties 202 are once again re-ranked in descending order of change in position risk, as exemplarily illustrated in FIG. 4N. Bond 1, the last remaining unallocated bond, is allocated to the counterparty with the highest change in position risk, Firm A. As exemplarily illustrated in FIG. 4O, Firm A now holds a position of $300 in Bond 1, while Firm B and Firm C hold a position of $0. Final position risks for all the counterparties 202 are computed. As illustrated in FIG. 4P, Firm A has a final position risk of $600, Firm B has a final position risk of $3300, and Firm C has a final position risk of $2700. Difference between the initial position risk and final position risk are computed for each one of the counterparties 202. As illustrated in FIG. 4P, Firm A has a difference of $50, Firm B has a difference of $0, and Firm C has a difference of −$50. The final position risks of the counterparties 202 are not significantly different from the initial position risks.

It will be readily apparent that the various methods and algorithms described herein may be implemented in a computer readable medium appropriately programmed for general purpose computers and computing devices. Typically a processor, for example, one or more microprocessors will receive instructions from a memory or like device, and execute those instructions, thereby performing one or more processes defined by those instructions. Further, programs that implement such methods and algorithms may be stored and transmitted using a variety of media, for example, computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, central processing unit (CPU) devices, computing devices, microcontrollers, digital signal processors or like devices. The term “computer readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include dynamic random access memory (DRAM), which typically constitutes the main memory. Transmission media include coaxial cables, copper wire and fiber optics, including the wires that comprise a system bus coupled to the processor. Common forms of computer readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer readable programs may be implemented in any programming language. Some examples of languages that can be used include C, C++, C#, or JAVA. The software programs may be stored on or in one or more mediums as an object code. A computer program product comprising computer executable instructions embodied in a computer readable medium comprises computer parsable codes for the implementation of the processes of various embodiments.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of distributing aggregated financial instruments among a plurality of counterparties, comprising:
acquiring financial instrument positions associated with financial instruments held by said counterparties along with one or more risk measures for each of said financial instruments, wherein said financial instruments are one of securities, derivatives, and a combination thereof;
weighting each of said held financial instrument positions using said acquired one or more risk measures to obtain risk weighted positions;
computing an aggregate risk for each of said financial instruments by aggregating said risk weighted positions of each of said financial instruments;
computing a position risk for each of said counterparties by aggregating said risk weighted positions of each of said counterparties;
allocating a financial instrument with highest aggregate risk from said financial instruments to a first counterparty with highest position risk from said counterparties based on a plurality of predefined rules;
recomputing a position risk for each of said counterparties by aggregating said risk weighted positions modified due to said allocation; and
allocating an unallocated financial instrument with highest aggregate risk from said financial instruments to a second counterparty with highest change in position risk after said recomputation, wherein said recomputation of said position risk and said allocation of unallocated financial instruments are performed until said allocation of said financial instruments is complete;
whereby said aggregated financial instruments are distributed among said counterparties.

2. The computer implemented method of claim 1, wherein said predefined rules allocate said financial instrument with said highest aggregate risk to said counterparty with said highest change in position risk if said counterparty holds a financial instrument position similar to and of the same sign as said financial instrument of at least a predefined value, wherein said sign denotes mode of trade of said financial instrument.

3. The computer implemented method of claim 1, further comprising ranking said financial instruments in descending order of said aggregate risk.

4. The computer implemented method of claim 1, further comprising ranking said counterparties in descending order of said position risk.

5. The computer implemented method of claim 4, further comprising re-ranking said counterparties in descending order of said change in position risk after each said allocation.

6. The computer implemented method of claim 1, further comprising computing position risks of said counterparties after said allocation of said financial instruments.

7. The computer implemented method of claim 6, further comprising computing difference between said position risks of said counterparties computed before said allocation and said position risks of said counterparties computed after said allocation.

8. The computer implemented method of claim 1, wherein said counterparties are buyers and sellers of similar financial instruments.

9. A computer implemented system for distributing aggregated financial instruments among a plurality of counterparties, comprising:
a position acquisition module that acquires financial instrument positions associated with financial instruments held by said counterparties along with one or more risk measures for each of said financial instruments, wherein said financial instruments are one of securities, derivatives, and a combination thereof;
a weighting engine that weights each of said held financial instrument positions using said acquired one or more risk measures to obtain risk weighted positions;
an aggregate risk computation module that computes an aggregate risk for each of said financial instruments by aggregating said risk weighted positions of each of said financial instruments;
a position risk computation module that computes a position risk for each of said counterparties by aggregating said risk weighted positions of each of said counterparties; and
an allocation engine that allocates a financial instrument with highest aggregate risk from said financial instruments to a first counterparty with highest position risk from said counterparties based on a plurality of predefined rules.

10. The computer implemented system of claim 9, wherein said position risk computation module recomputes a position risk for each of said counterparties by aggregating said risk weighted positions modified due to said allocation.

11. The computer implemented system of claim 10, wherein said allocation engine allocates an unallocated financial instrument with highest aggregate risk from said financial instruments to a second counterparty with highest change in position risk after said recomputation, wherein said recomputation of said position risk and said allocation of unallocated financial instruments are performed until said allocation of said financial instruments is complete.

12. The computer implemented system of claim 9, wherein said allocation engine utilizes said predefined rules to allocate said financial instrument with said highest aggregate risk to said counterparty with said highest change in position risk if said counterparty holds a financial instrument position similar to and of same sign as said financial instrument of at least a predefined value, wherein said sign denotes mode of trade of said financial instrument.

13. The computer implemented system of claim 9, further comprising a ranking module that ranks said financial instruments in descending order of said aggregate risk, said counterparties in descending order of said position risk, and re-ranking said counterparties in descending order of said change in position risk after each said allocation.

14. The computer implemented system of claim 9, wherein said position risk computation module computes position risks of said counterparties after said allocation of said financial instruments.

15. The computer implemented system of claim 14, further comprising a difference computation module that computes difference between said position risks of said counterparties computed before said allocation and said position risks of said counterparties computed after said allocation.

16. A computer program product comprising computer executable instructions embodied in a computer readable storage medium, wherein said computer program product comprises:
a first computer parsable program code for acquiring financial instrument positions associated with financial instruments held by a plurality of counterparties along with one or more risk measures for each of said financial instruments, wherein said financial instruments are one of securities, derivatives, and a combination thereof;
a second computer parsable program code for weighting each of said held financial instrument positions using said acquired one or more risk measures to obtain risk weighted positions;
a third computer parsable program code for computing an aggregate risk for each of said financial instruments by aggregating said risk weighted positions of each of said financial instruments;
a fourth computer parsable program code for computing a position risk for each of said counterparties by aggregating said risk weighted positions of each of said counterparties;
a fifth computer parsable program code for allocating a financial instrument with highest aggregate risk from said financial instruments to a first counterparty with highest position risk from said counterparties based on a plurality of predefined rules;
a sixth computer parsable program code for recomputing a position risk for each of said counterparties by aggregating said risk weighted positions modified due to said allocation; and
a seventh computer parsable program code for allocating an unallocated financial instrument with highest aggregate risk from said financial instruments to a second counterparty with highest change in position risk after said recomputation, wherein said recomputation of said position risk and said allocation of unallocated financial instruments are performed until said allocation of said financial instruments is complete.
